(19) United States
(12) Patent Application Publication
(10) Pub. No.: US 2026/0308316 A1
(43) Pub. Date: Oct. 8, 2026

(54) MANUFACTURING METHOD OF POLYETHYLENE FURANDICARBOXYLATE

(71) Applicant: NAN YA PLASTICS CORPORATION, Taipei City (TW)

(72) Inventors: Ching-Yao Yuan, Taipei City (TW); Cheng-Shui Huang, Taipei City (TW); Chung Yu Chen, Taipei City (TW); Mong-Chen Chang, Taipei City (TW); Zhang-Jian Huang, Taipei City (TW)

(73) Assignee: NAN YA PLASTICS CORPORATION, Taipei City (TW)

(21) Appl. No.: 19/199,399

(22) Filed: May 6, 2025

(30) Foreign Application Priority Data
Apr. 2, 2025 (TW) 114112847

(51) Int. Cl. C08G 63/86; C08G 63/181; C08G 63/78; C08G 63/87; C08K 5/09; C08K 5/19

(52) U.S. Cl. CPC C08G 63/866; C08G 63/181; C08G 63/785; C08G 63/87; C08K 5/09; C08K 5/19

(57) ABSTRACT

Provided is a manufacturing method of polyethylene furandicarboxylate, comprising following steps. A biomass 2,5-furandicarboxylic acid and a biomass ethylene glycol are subjected to an esterification reaction, and a byproduct of the esterification reaction is water. Next, a polymerization reaction is performed in the presence of a catalyst and a diethylene glycol inhibitor to the prepare polyethylene furandicarboxylate. The diethylene glycol inhibitor includes sodium acetate, tetraethylammonium hydroxide, or a combination thereof.

### CROSS-REFERENCE TO RELATED APPLICATION

This application claims the priority benefit of Taiwan application serial no. 114112847, filed on Apr. 2, 2025. The entirety of the above-mentioned patent application is hereby incorporated by reference herein and made a part of this specification.

### BACKGROUND

### Technical Field

The disclosure relates to a manufacturing method of polyethylene furandicarboxylate, and in particular to a high quality manufacturing method of polyethylene furandicarboxylate.

### Related Art

Polyethylene furan 2,5 dicarboxylate (PEF) is a biomass polyester, which has low emission, and has advantages of good gas barrier properties, good thermal stability, high Tg point, and better mechanical strength, and mainly applied in food and beverage packaging, films and flexible packaging, and fibers, etc.

A manufacturing method of the PEF may be mainly divided into two types. The first type of the method is performing an esterification reaction and a polymerization reaction by using a biomass 2,5 Furandicarboxylic acid, 2,5-dimethylester (FDME) and a biomass ethylene glycol (EG) as raw materials to prepare PEF, and a byproduct is water. The second type of the method is performing an esterification reaction and a polymerization reaction by using a biomass 2,5-furandicarboxylic acid (FDCA) and a biomass ethylene glycol (EG) as raw materials to prepare PEF, and a byproduct is water.

If the known manufacturing method of PEF uses FDME and EG as raw materials (the first type of the method mentioned above), compared with the second type of the method mentioned above, the manufactured PEF has methanol as a byproduct. In the process, the byproduct of methanol is not easily condensed and collected, so the manufacturing equipment and energy consumption are relatively high, and a molecular weight of FDME is higher than a molecular weight of FDCA. By using the same manufacturing equipment, the production is relatively low; therefore, using FDCA is relatively advantageous when considering the raw material. Although the second type of the aforementioned manufacturing method of PEF with water as the byproduct is relatively advantageous in the process, the manufactured PEF has a poorer CIELAB color space (brightness L<65 and yellowness b>15) and a high content of a diethylene glycol (DEG), which affects the processability. Therefore, further improvement is needed.

Based on the above, developing a manufacturing method of high quality polyethylene furandicarboxylate, to improve the CIELAB color space of polyethylene furandicarboxylate and reduce the content of diethylene glycol content, is an important issue in the industry currently.

### SUMMARY

The disclosure provides a manufacturing method of polyethylene furandicarboxylate, to improve a CIELAB color space of polyethylene furandicarboxylate and reduce a content of a diethylene glycol.

The method for manufacturing of polyethylene furandicarboxylate of the disclosure includes following steps. A bio-based 2,5-furandicarboxylic acid and a biomass ethylene glycol are subjected to an esterification reaction, where a byproduct of the esterification reaction is water. Next, a polymerization reaction is performed in the presence of a catalyst and a diethylene glycol inhibitor to prepare polyethylene furandicarboxylate, where the diethylene glycol inhibitor includes sodium acetate, tetraethylammonium hydroxide, or a combination thereof.

In an embodiment of the disclosure, an addition amount of the diethylene glycol inhibitor is 5 ppm to 100 ppm of a total amount of the biomass ethylene glycol and the bio-based 2,5-furandicarboxylic acid.

In an embodiment of the disclosure, an addition amount of the catalyst is 200 ppm to 800 ppm of a total amount of the biomass ethylene glycol and the bio-based 2,5-furandicarboxylic acid.

In an embodiment of the disclosure, a molar ratio of the biomass ethylene glycol to the bio-based 2,5-furandicarboxylic acid for performing the esterification reaction is 2.1 to 1.0.

In an embodiment of the disclosure, a temperature of the esterification reaction is 170° C. to 210° C.

In an embodiment of the disclosure, a pressure of the esterification reaction is 1 bar to 1.5 bar.

In an embodiment of the disclosure, time of the esterification reaction is 1 hour to 6 hours.

In an embodiment of the disclosure, a temperature of the polymerization reaction is 220° C. to 280° C.

In an embodiment of the disclosure, time of the polymerization reaction is 1 hour to 7 hours.

In an embodiment of the disclosure, a pressure of the polymerization reaction is 0.2 torr to 20 torr.

In an embodiment of the disclosure, a diethylene glycol content of the manufactured polyethylene furandicarboxylate is less than 5 mol %.

In an embodiment of the disclosure, the manufactured polyethylene furandicarboxylate has a CIELAB color space of L greater than 65% and b less than 15.

In an embodiment of the disclosure, the manufactured polyethylene furandicarboxylate has an intrinsic viscosity greater than 0.60.

In an embodiment of the disclosure, the manufactured polyethylene furandicarboxylate has a Tg point greater than 82° C.

In an embodiment of the disclosure, the catalyst includes an organometallic and an ionic liquid. The organometallic includes zinc acetate, organic titanium, organic antimony, or organic aluminum. The ionic liquid includes 1-butyl-3-methylimidazolium hexa-fluoro-phosphate (BMI-PF6), 1-butyl-3-methylimidazolium tetra-fluoro-borate (BMI-BF4), or a combination thereof.

Based on the above, the disclosure provides a manufacturing method of the polyethylene furandicarboxylate. Preparing the polyethylene furandicarboxylate by using the biomass 2,5-furandicarboxylic acid and the biomass ethylene glycol as raw materials, and the byproduct is water. Therefore, the process is relatively advantageous in terms of production cost and environmental concept. In addition, the disclosure adopts a lower temperature of the esterification reaction, better thermal history, and a low ratio of alcohol-acid, and adds sodium acetate or tetraethylammonium hydroxide (TEAH) in the stage of the polymerization reaction. As a result, the manufactured polyethylene furandicarboxylate has advantages of the good CIELAB color space and low content of the diethylene glycol.

### DESCRIPTION OF THE EMBODIMENTS

Embodiments of the disclosure are described in detail as follows. However, these embodiments are exemplary, and the disclosure is not limited thereto.

In the disclosure, a range expressed by “from one numerical value to another numerical value” is a summary representation to avoid listing all values within that range in the specification. Therefore, the description of a specific numerical range encompasses any value within that numerical range as well as smaller numerical ranges defined by any values within that numerical range, as if such arbitrary values and smaller numerical ranges were explicitly written out in the specification.

The disclosure provides a manufacturing method of polyethylene furandicarboxylate, including following steps. A biomass 2,5-furandicarboxylic acid and a biomass ethylene glycol are subjected to an esterification reaction, and a byproduct of the esterification reaction is water. Next, a polymerization reaction is performed in the presence of a catalyst and a diethylene glycol inhibitor to prepare polyethylene furandicarboxylate. The diethylene glycol inhibitor includes sodium acetate, tetraethylammonium hydroxide, or a combination thereof.

In this embodiment, a molar ratio of the biomass ethylene glycol to the biomass 2,5-furandicarboxylic acid in the esterification reaction may be 2.1 to 1.0, preferably 1.5 to 1.2. A temperature of the esterification reaction may be 170° C. to 210° C., preferably 180° C. to 200° C. A pressure of the esterification reaction may be 1 bar to 1.5 bar. Time of the esterification reaction may be 1 hour to 6 hours, preferably 2 hours to 5 hours. The disclosure mainly adopts a lower temperature of the esterification reaction, which provides better thermal history, thereby achieving the purpose of energy conservation and carbon reduction. Additionally, the formation of coloring substances and the diethylene glycol may be inhibited.

In this embodiment, the catalyst may include an organometallic and an ionic liquid. The organometallic may include zinc acetate, organic titanium, organic antimony, or organic aluminum. The ionic liquid may include 1-butyl-3-methylimidazolium hexa-fluoro-phosphate, 1-butyl-3-methylimidazolium tetra-fluoro-borate, or a combination thereof. The addition amount of the catalyst may be 200 ppm to 800 ppm of a total amount of the biomass ethylene glycol and the biomass 2,5-furandicarboxylic acid. The diethylene glycol inhibitor may include sodium acetate, tetraethylammonium hydroxide, or a combination thereof. The addition amount of the diethylene glycol inhibitor may be 5 ppm to 100 ppm of the total amount of the biomass ethylene glycol and the biomass 2,5-furandicarboxylic acid, preferably 10 ppm to 50 ppm. By adding the diethylene glycol inhibitor, the formation of diethylene glycol may be inhibited under a vacuum condition.

In this embodiment, a temperature of the polymerization reaction may be 220° C. to 280° C., preferably 230° C. to 270° C. Time of the polymerization reaction may be 1 hour to 7 hours, preferably 2 hours to 6 hours. A pressure of the polymerization reaction may be 0.2 torr to 20 torr, preferably 0.5 torr to 10 torr.

In this embodiment, the manufactured polyethylene furandicarboxylate has a content of the diethylene glycol less than 5 mol %, a CIELAB color space of L greater than 65%, b less than 15, an intrinsic viscosity (IV) greater than 0.60, and a Tg point greater than 82° C.

The following experimental examples are used to describe details of the aforementioned manufacturing method of the polyethylene furandicarboxylate of the disclosure, but are not intended to limit the disclosure.

### EXPERIMENTAL EXAMPLE

### Example 1

### (1) Experimental Equipment

A three-neck flask with a stirring function is equipped with a distillation column with 12 theoretical plates.

### (2) Esterification Reaction

148.8 grams of the biomass ethylene glycol (2.4 mole) and 312.2 g of the biomass 2,5-furandicarboxylic acid (2 mole) were placed in the three-neck flask to be subjected to the esterification reaction with a temperate maintained at 190° C. for 3 hours, and with a pressure maintained at 1 bar (atmospheric pressure). The top of the distillation column of the three-neck flask was controlled at 100° C., which may separate the vapor (the byproducts are water and ethylene glycol). The H₂O vapor may be discharged from the top of the distillation column and further condensed, while the ethylene glycol was condensed at the top of the distillation column and refluxed back to the three-neck flask to continue the esterification reaction. A total of 36 g of water was collected from the entire process.

### (3) Polymerization Reaction

0.12 grams (260 ppm) of antimony trioxide (Sb₂O₃) as a catalyst, and 0.010 grams (22 ppm) of sodium acetate as a diethylene glycol inhibitor were added to the three-neck flask and stirred for 30 minutes. Afterwards, a vacuum system was established with a pressure reduction rate of 5 torr/min, reducing the pressure in a reaction vessel to 1 torr. The temperature was then raised from 190° C. to 265° C., and maintained at 265° C. for 4 hours to complete the polymerization reaction.

### (4) Quality of PEF

The PEF obtained from the experiment has a CIELAB color space of L=71.2%, a b value=12.8, a content of the diethylene glycol=4.2 mol %, IV=0.62, and Tg-84.2.

### Example 2 to Example 6

The temperature of the esterification reaction was changed, and the diethylene glycol inhibitor and the addition amount thereof were changed, while the rest remained the same as Example 1. The quality of the PEF including L, b, the content of the diethylene glycol, and IV are listed in Table 1.

TABLE 1

| | | | Example | Example | Example | Example | Example | Example |
|---|---|---|---|---|---|---|---|---|
| | | | 1 | 2 | 3 | 4 | 5 | 6 |
| Raw material | EG(g) | | 148.8 | | 161.2 | | 186 | |
| | FDCA(g) | | 312.2 | | 312.2 | | 312.2 | |
| Conditions of | Temperature (° C.) | | 190 | 187 | 184 | 180 | 195 | 200 |
| esterification | Pressure (torr) | | 760 | 760 | 760 | 760 | 760 | 760 |
| reaction | Time (hr) | | 3.0 | 3.0 | 3.0 | 3.0 | 3.0 | 3.0 |
| Conditions of | Catalyst | Name | Antimony trioxide (Sb₂O₃) | | | | | |
| polymerization | | Weight | 0.12 | 0.12 | 0.16 | 0.18 | 0.19 | 0.26 |
| reaction | | (kg) | | | | | | |
| | DEG | Name | Sodium acetate | | Sodium acetate | | Tetraethylammonium | |
| | inhibitor | | | | | | hydroxide | |
| | | Weight | 0.010 | 0.012 | 0.015 | 0.018 | 0.010 | 0.021 |
| | | (kg) | | | | | | |

| | | | | | | | |
|---|---|---|---|---|---|---|---|
| | Temperature (° C.) | 265 | 265 | 270 | 270 | 265 | 270 |
| | Pressure (torr) | 1.0 | 1.1 | 1.0 | 1.3 | 1.1 | 1.2 |
| | Time (hr) | 4.0 | 4.0 | 4.0 | 4.0 | 4.0 | 4.0 |
| Quality of PEF | L(%) | 71.2 | 70.9 | 68.7 | 67.0 | 68.4 | 65.7 |
| | b | 12.8 | 12.0 | 11.9 | 11.4 | 13.3 | 14.7 |
| | DEG(mol %) | 4.2 | 3.8 | 3.6 | 3.5 | 3.9 | 4.8 |
| | IV | 0.62 | 0.63 | 0.65 | 0.65 | 0.68 | 0.71 |

As shown in Table 1, Examples 1 to 6 adopt the manufacturing method of the polyethylene furandicarboxylate of the disclosure. The biomass 2,5-furandicarboxylic acid and the biomass ethylene glycol are used as raw materials to prepare polyethylene furandicarboxylate, and the byproduct is water. Therefore, the process is relatively advantageous in terms of production cost and environmental protection concepts. In addition, by adopting a lower temperature of the esterification reaction with better thermal history, the purpose of energy conservation and carbon reduction may be achieved. Furthermore, by adopting a low ratio of alcohol-to-acid and adding sodium acetate or tetraethylammonium hydroxide (TEAH) in the stage of the polymerization reaction, the manufactured polyethylene furandicarboxylate has advantages of a good CIELAB color space and a low content of the diethylene glycol.

### Comparative Example 1

### (1) Experimental Equipment

A three-neck flask with a stirring function is equipped with a distillation column with 12 theoretical plates.

### (2) Esterification Reaction

148.8 g of the biomass ethylene glycol (2.4 mole) and 312.2 g of the biomass 2,5-furandicarboxylic acid (2 mole) were placed in the three-neck flask to be subjected to the esterification reaction with a temperature maintained at 220° C. for 2.5 hours, and with a pressure maintained at 1.96 bar. The top of the distillation column of the three-neck flask was controlled at 121° C., which may separate the vapor (the byproducts are water and ethylene glycol). The H₂O vapor may be discharged from the top of the distillation column and further condensed, while the ethylene glycol was condensed at the top of the distillation column and refluxed back to the three-neck flask to continue the esterification reaction. A total of 36 g of water was collected from the entire process.

### (3) Polymerization Reaction

0.12 g (260 ppm) of antimony trioxide (Sb₂O₃) as a catalyst was added to the three-neck flask and stirred for 30 minutes. Afterwards, a vacuum system was established with a pressure reduction rate of 5 torr/min, reducing the pressure in the reaction vessel to 1 torr. The temperature was then raised from 190° C. to 265° C., and maintained at 265° C. for 4 hours to complete the polymerization reaction.

### (4) Quality of PEF

The PEF obtained from the experiment has a CIELAB color space L=59.2%, a b value=21.8, a content of the diethylene glycol=6.4 mol %, and IV=0.61.

### Comparative Example 2 to Comparative Example 6

The temperatures of the esterification reaction and polymerization reaction were changed respectively, and the molar ratio of EG/FDCA was changed, while the rest remained the same as in Comparative example 1. The quality of the PEF including L, b, the content of the diethylene glycol content, and IV are listed in Table 2.

TABLE 2

| | | | Comparative | Comparative | Comparative | Comparative | Comparative | Comparative |
|---|---|---|---|---|---|---|---|---|
| | | | example 1 | example 2 | example 3 | example 4 | example 5 | example 6 |
| Raw material | EG(g) | | 148.8 | | 161.2 | | 186 | |
| | FDCA(g) | | 312.2 | | 312.2 | | 312.2 | |
| Conditions of | Temperature (° C.) | | 220 | 230 | 230 | 240 | 220 | 240 |
| esterification | Pressure (torr) | | 1.96 | 2.43 | 2.43 | 3.15 | 1.96 | 3.15 |
| reaction | Time (hr) | | 2.5 | 2.5 | 2.5 | 2.5 | 2.5 | 2.5 |
| Conditions of | Catalyst | Name | Antimony trioxide (Sb₂O₃) | | | | | |
| polymerization | | Weight | 0.12 | 0.12 | 0.16 | 0.18 | 0.19 | 0.26 |
| reaction | | (kg) | | | | | | |

| | DEG inhibitor | None | | None | | None | |
|---|---|---|---|---|---|---|---|
| | Temperature (° C.) | 265 | 265 | 270 | 270 | 265 | 270 |
| | Pressure (torr) | 1.0 | 1.1 | 1.0 | 1.3 | 1.1 | 1.2 |
| | Time (hr) | 4.0 | 4.0 | 4.0 | 4.0 | 4.0 | 4.0 |
| Quality of PEF | L(%) | 59.2 | 60.7 | 59.9 | 61.2 | 63.8 | 63.0 |
| | b | 21.8 | 22.4 | 22.7 | 23.1 | 21.4 | 23.4 |
| | DEG(mol %) | 6.4 | 6.7 | 6.5 | 7.0 | 7.4 | 7.8 |
| | IV | 0.61 | 0.63 | 0.61 | 0.62 | 0.62 | 0.64 |

As shown in Table 2, unlike the manufacturing method of polyethylene furandicarboxylate of the disclosure, Comparative examples 1 to 6 have higher temperatures of the esterification reaction and do not add diethylene glycol inhibitors. Therefore, the manufactured PEF has the poorer CIELAB color space and higher content of the diethylene glycol, and has no advantages of energy saving and carbon reduction.

In summary, the disclosure provides a manufacturing method of the polyethylene furandicarboxylate. The biomass 2,5-furandicarboxylic acid and biomass ethylene glycol are used as raw materials to prepare polyethylene furandicarboxylate, and the byproduct is water. Therefore, the process is relatively advantageous in terms of production cost and environmental protection concepts, with advantages in economic benefits. In addition, the disclosure adopts the lower temperature of the esterification reaction with better thermal history, thereby achieving the purpose of energy saving and carbon reduction. Furthermore, by adopting a low ratio of alcohol-to-acid and adding sodium acetate or tetraethylammonium hydroxide in the stage of the polymerization reaction, the manufactured polyethylene furandicarboxylate has advantages of the good CIELAB color space and low content of the diethylene glycol, thereby improving subsequent processability.

What is claimed is:

1. A manufacturing method of polyethylene furandicarboxylate, comprising:
performing an esterification reaction by a biomass 2,5-furandicarboxylic acid and a biomass ethylene glycol, wherein a byproduct of the esterification reaction is water; and
performing a polymerization reaction in presence of a catalyst and a diethylene glycol inhibitor to prepare the polyethylene furandicarboxylate, wherein the diethylene glycol inhibitor comprises sodium acetate, tetraethylammonium hydroxide, or a combination thereof.

2. The manufacturing method of the polyethylene furandicarboxylate according to claim 1, wherein an addition amount of the diethylene glycol inhibitor is 5 ppm to 100 ppm of a total amount of the biomass ethylene glycol and the biomass 2,5-furandicarboxylic acid.

3. The manufacturing method of the polyethylene furandicarboxylate according to claim 1, wherein an addition amount of the catalyst is 200 ppm to 800 ppm of a total amount of the biomass ethylene glycol and the biomass 2,5-furandicarboxylic acid.

4. The manufacturing method of the polyethylene furandicarboxylate according to claim 1, wherein a molar ratio of the biomass ethylene glycol to the biomass 2,5-furandicarboxylic acid for performing the esterification reaction is 2.1 to 1.0.

5. The manufacturing method of the polyethylene furandicarboxylate according to claim 1, wherein a temperature of the esterification reaction is 170° C. to 210° C.

6. The manufacturing method of the polyethylene furandicarboxylate according to claim 1, wherein a pressure of the esterification reaction is 1 bar to 1.5 bar.

7. The manufacturing method of the polyethylene furandicarboxylate according to claim 1, wherein time of the esterification reaction is 1 hour to 6 hours.

8. The manufacturing method of the polyethylene furandicarboxylate according to claim 1, wherein a temperature of the polymerization reaction is 220° C. to 280° C.

9. The manufacturing method of the polyethylene furandicarboxylate according to claim 1, wherein time of the polymerization reaction is 1 hour to 7 hours.

10. The manufacturing method of the polyethylene furandicarboxylate according to claim 1, wherein a pressure of the polymerization reaction is 0.2 torr to 20 torr.

11. The manufacturing method of the polyethylene furandicarboxylate according to claim 1, wherein a diethylene glycol content of the manufactured polyethylene furandicarboxylate is less than 5 mol %.

12. The manufacturing method of the polyethylene furandicarboxylate according to claim 1, wherein the manufactured polyethylene furandicarboxylate has a CIELAB color space of L greater than 65% and b less than 15.

13. The manufacturing method of the polyethylene furandicarboxylate according to claim 1, wherein the manufactured polyethylene furandicarboxylate has an intrinsic viscosity greater than 0.60.

14. The manufacturing method of the polyethylene furandicarboxylate according to claim 1, wherein the manufactured polyethylene furandicarboxylate has a Tg point greater than 82° C.

15. The manufacturing method of the polyethylene furandicarboxylate according to claim 1, wherein the catalyst comprises an organometallic and an ionic liquid, the organometallic comprises zinc acetate, organic titanium, organic antimony, or organic aluminum, and the ionic liquid comprises 1-butyl-3-methylimidazolium hexa-fluoro-phosphate, 1-butyl-3-methylimidazolium tetra-fluoro-borate, or a combination thereof.
